(19) United States
(12) Patent Application Publication
(10) Pub. No.: US 2005/0005723 A1
(43) Pub. Date: Jan. 13, 2005

(54) Reduction gear of a multi-range-gearbox for a vehicle

(76) Inventors: Christoph Pelchen, Tettnang (DE); Unal Gazyakan, Friedrichshafen (DE); Barbara Schmohl, Friedrichshafen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/880,204

(22) Filed: Jun. 29, 2004

(30) Foreign Application Priority Data
Jul. 11, 2003 (DE) 103 31 374.5

(51) Int. Cl. G05G 5/00

(52) U.S. Cl. 74/473.21

(57) ABSTRACT

A reduction gear (3) of a multi-range transmission (1) for a vehicle, especially for an all-wheel vehicle, having at least two ratio steps. The reduction gear (3) is situated between a main transmission (2) and one output of the vehicle and designed with at least one parking lock device (22A, 22B) by means of which, in activated state, at least one part of the output can be stopped. The parking lock device (22A, 22B) is associated on the transmission output side with at least one output shaft (7, 8) so that the output of the vehicle in activated state of the parking lock device (22A, 22B) can be stopped even when the power flow is interrupted in a drive train in the area of the reduction gear (3).

The invention concerns a reduction gear of a multi-range transmission for a vehicle, specially for an all-wheel vehicle, having at least two ratio steps and disposed between a main transmission and an output of the vehicle.

In the practice, multi-range transmission are used in all-wheel operated vehicles consisting each of one multi-step automatic transmission and one reduction gear rear-mounted on the automatic transmission. The reduction gears are designed with an electromechanical or with a hydraulic actuation system by means of which it is possible to change between a first ratio “low” and a second ratio “high”. In addition such reduction gears are designed with a regulatable clutch by means of a permanent drive axle of a vehicle of which one other drive axle can be connected for constituting an all-wheel drive.

If the vehicle is stationary and a driver of the vehicle selects a shift position, via a selector device in which a parking lock device of the vehicle is activated in order to prevent the vehicle from rolling off while parked, the parking lock located in the drive train of the vehicle in the area of the main transmission is activated and stops the output.

If, for example, during a change from the ratio step “low” to the ratio step “high” the actuation system of the reduction gear fails on account of a breakdown of the power supply or on account of a defective cable, for example, and the reduction gear finds itself in a shift condition in which the power flow to the reduction gear is interrupted, the vehicle disadvantageously is not protected against an undesired rolling off even when the parking lock device is activated such as can occur, for example, in a hill position, since the power flow has been interrupted in the drive train in the area of the reduction gear between the parking lock device and the output of the vehicle.

DE 198 31 069 A1 has disclosed a vehicle in which two wheels are respectively associated with one prime mover with one reduction gear. The prime mover is located in the proximity of a wheel hub of the associated wheel and connected with the wheel hub by the reduction gear. The prime mover and a respective appertaining wheel are on the same side of the associated reduction gear, the wheel hubs being coaxially aligned relative to each other and connected with their reduction gear by a respective plug shaft. Each one of the reduction gears has one intermediate shaft supported by its ends via roller bearings in a housing sidewall on one side and in a middle portion of the housing in the other. The intermediate shaft is in operative connection with the prime mover via a gear wheel step the input pinion of which sits non-rotatable on an armature shaft and with the plug shaft, via one other gear wheel step, the input gear wheel of which sits non-rotatably on the end of the plug shaft.

Upon each intermediate shaft is also provided a non-rotatably designed pawl wheel of a parking lock system with which can be brought to positive fit engagement an appertaining parking lock pawl pivotably supported in a housing middle portion by mediation of a bearing bolt.

However, it is disadvantageous that the reduction gear has only one ratio step available and the parking lock device is integrated in the reduction gear so that the reduction gear can be designed only with large outer dimensions.

The problem on which this invention is based is to make a reduction gear available by means of which the parking lock device is activated, a rolling off of the vehicle is prevented in all operating states of the reduction gear and a compact design is made possible.

This problem is solved according to the invention with a reduction gear for a vehicle, specially for an all-wheel vehicle, according to the features of claim 1.

In such a reduction gear of a multi-range transmission, which is designed with at least two ratio steps and with at least one parking lock device and which is situated between a main transmission and an output of the vehicle, the parking lock function is advantageously ensured even in case of failure of the reduction gear or of the reduction step actuation system when the parking lock device is associated with at least one output shaft of the reduction gear so that the output of the vehicle, when the parking lock is activated, is stopped even if the power flow of a drive train is interrupted in the area of the reduction gear.

The inventive reduction gear has, in addition, a simple and compact structural arrangement since the parking lock device is situated on the output side of the transmission. It is thus possible, for example, to place the parking lock device outside the transmission housing of the reduction gear whereby a specially compact construction of the reduction gear can be implemented.

It is further advantageous in the inventive reduction gear that without expensive constructional modifications, it can be put into effect in existing production line transmission.

Other advantages and advantageous developments of the object of the invention can be understood form the description, the drawing and the claims. In the drawing:

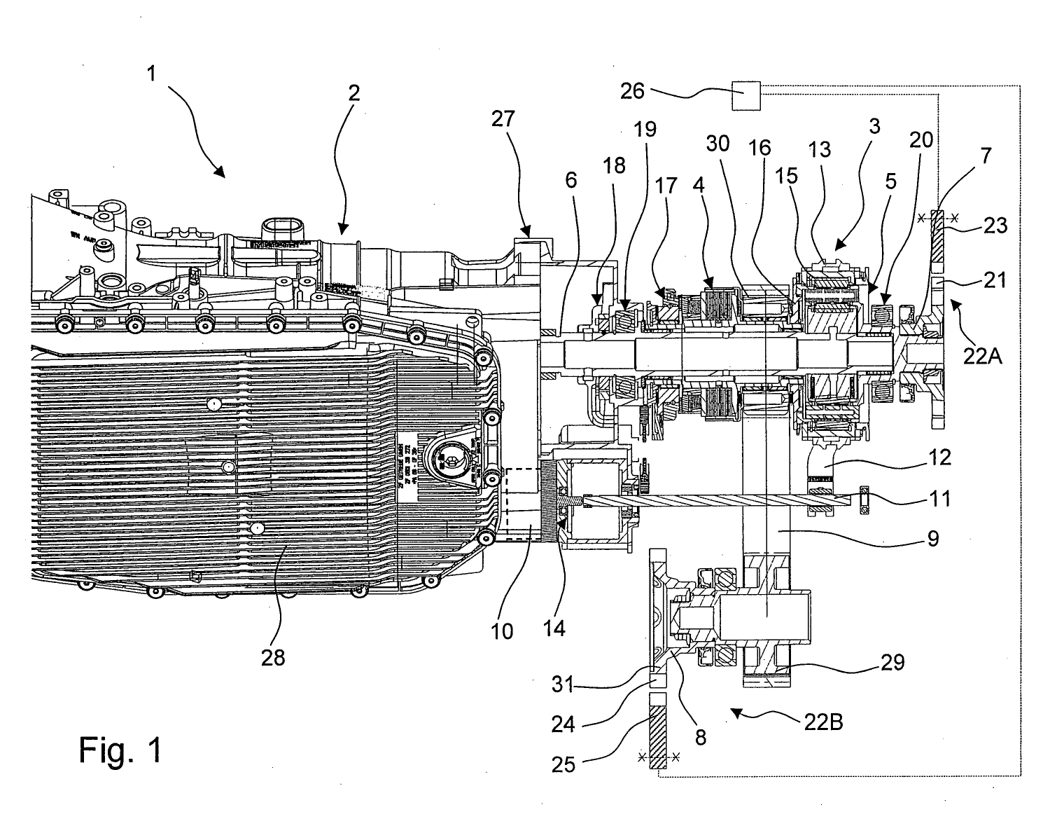

FIG. 1 is a first embodiment of a multi-range transmission comprising one main transmission and one reduction gear; and

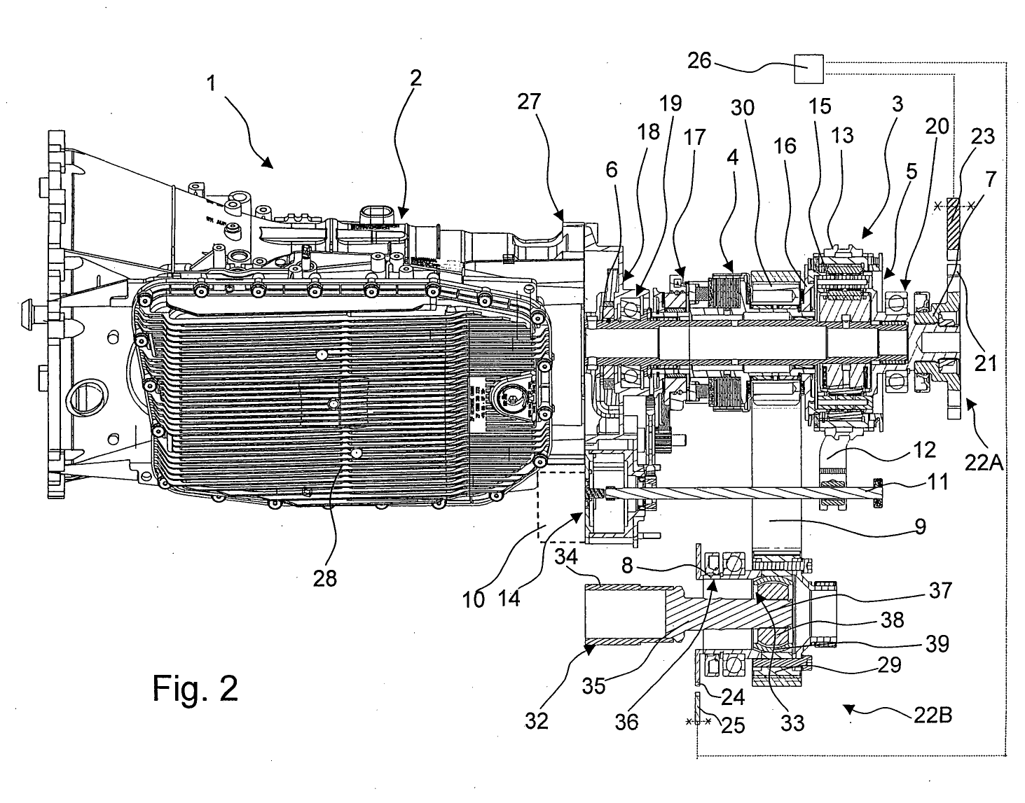

FIG. 2 is a second embodiment of a multi-range transmission having one main transmission and one inventive reduction gear.

Referring to FIG. 1, it shows one multi-range transmission 1 comprising one main transmission 2 and one reduction gear 3 with one regulatable clutch 4 for a vehicle with all-wheel operation (not shown in detail). The reduction gear 3 is designed with one planetary gear set 5 as ratio step or reduction step for a cross country gear engageable during the travel; it is possible to change between a first ratio step “low” and a second ratio step “high”.

When changing between the ratio step “low” and the ratio step “high” an intermediate shift step is provided in which a power flow of the drive train of the vehicle is interrupted in the area of the reduction gear 3.

An input torque generated by a prime mover (not shown in detail), is introduced in the reduction gear 3 via an input shaft 6 as a changed output torque of the main transmission 2 and is passed via a first output shaft 7 and a second output shaft 8 to two input axles of the vehicle (not shown in detail), the second output shaft 8 is driveable by the input shaft 6 via a chain 9.

The connection between the input shaft 6 and the second output shaft 8 can be regulated via the clutch 4 designed as multi-disc clutch in a manner such that the connection is created by an engagement or closing of the clutch 4 and is interrupted when the clutch 4 is open. The all-wheel drive is thus engaged or disengaged via the clutch 4 and combined with the chain 9 constitutes a so-called distributor unit for optional distribution of an output torque to the first output shaft 7 or to both output shafts 7, 8 of the reduction gear 3 additionally designed as distributor gear.

The clutch 4 is actuated, that is, the clutch 4 is engaged and disengaged, via an electric motor 10, depending on the momentary adjusted direction of rotation of the electric motor 10 whether the clutch 4 is opened or closed. Besides, the planetary gear set 5 is also actuated via the electric motor 10. For the purpose, the electric motor 10 is operatively connected with the planetary gear set 5 via a shaft 11, a swinger 12 and a sliding sleeve 13.

The shaft 11 is adjusted in axial direction of the reduction gear 3 via a ball threaded drive 14 whereby the sliding sleeve 13 can be moved between two shift positions.

In a first of the shift positions of the sliding sleeve 13, a ring gear 15 of the planetary gear set 5 is connected with a web 16 of the planetary gear set 5.

If the sliding sleeve 13 is in its second shift position, the ring gear 15 is fixedly connected with a transmission housing (not shown in detail), of the reduction gear 3. The cross country gear “low” of the reduction gear 3 is activated when the ring gear 15 is fixedly connected with the transmission housing of the reduction gear 3 via a dog toothing of the sliding sleeve 13. If the ring gear 15 is fixedly connected via the dog toothing of the sliding sleeve 13 with the web 16 of the planet carrier of the planetary gear set 5, the cross country gear of the reduction gear 3 is then deactivated and the ratio step “high” is adjusted.

The regulatable clutch 4 is actuated via a transmission device 17 provided between the electric motor 10 and the clutch 4 and its mode of operation substantially corresponds to that of the ball threaded drive 14 combined with the swinger 12, that is, the transmission device 17 transforms the rotatory movement of the electric motor 10 to a translatory actuation movement thus making an actuation of the clutch 4 possible via the electric motor 10.

Upon the end of the reduction gear 3 remote from the planetary gear set 5, a hydraulic pump 18 is directly situated upon the input shaft 6 which is provided for oil supply of the reduction gear 3 and is driven at the rotational speed of the input shaft 6. The arrangement of the hydraulic pump 18 guarantees that the hydraulic pump 18 has a constant delivery capacity even when the cross country gear is engaged, since an input rotational speed remains constant due to the change of ratio when shifting the cross country step for the hydraulic pump 18.

The hydraulic pump 18 is also situated upon the input shaft 6 before a first transmission bearing 19 whereby a spacing between the first transmission bearing 19 and a second transmission bearing 20 is smaller than when the pump is disposed between the two bearings 19, 20. This results in minimizing the bending load of the input shaft 6 and of the first output shaft 7 so that the shafts 6 and 7 can be dimensioned smaller with regard to the bending load. Thereby is achieved a weight reduction and a lowering in production costs of the reduction gear 3.

On an outer side of an area of flange-like design of the first output shaft 7, the latter is designed with an outer toothing 21, the flange-like area of the first output shaft 7 forming with the outer toothing 21 a first parking lock wheel of a parking lock device 22A.

When the parking lock device 22A is activated or introduced, a parking lock pawl 23 is engaged with the outer toothing 21 of the first output shaft 7 so that the vehicle drive axle operatively connected with the first output shaft 7 or the part of the output of the vehicle operatively connected with the first output shaft 7 is stopped so that the vehicle is protected against an automatic rolling even when the power flow of the drive train is interrupted in the area of the reduction gear 3 since, between the output of the vehicle and the parking lock device 22A of the first output shaft 7, the power flow is not interrupted.

The second output shaft 8 is additionally constructed with one connecting area of flange-like design or with one output flange 31 for one other vehicle drive axle, the connecting area being provided in the same manner as the first output shaft 7 with one outer toothing 24 which is part of one other parking lock device 22B and constitutes the parking lock wheel of the outer parking lock device 22B.

When the added parking lock device 22B is activated, one other parking lock pawl 25 engages in the outer toothing 24 of the second output shaft 8. Both parking lock pawls 23 and 25 are controlled by one control device 26. The parking lock devices 22A, 22B are controlled so that either the parking lock pawl 23 engages in the outer toothing 21 or the other parking lock pawl 25 engages in the outer toothing 24 of the second output shaft 8. It can further be provided that both parking lock pawls 23 and 25 be engaged in the respective outer toothing 21 or 24 corresponding therewith in order simultaneously non-rotatably to connect both parts of the output, that is, the first output shaft 7 and the second output shaft 8, with a housing of the reduction gear 3 or another part on the vehicle side and reliably to prevent rolling off of the vehicle.

The last mentioned procedure is especially advantageous when the driving wheels of the vehicle, which are stopped by the parking lock device 22A, stand on slippery soil and the vehicle slips off despite activated parking lock devices 22A and 22B. In such a situation, the drive wheels of the other vehicle drive axle, which have not been stopped by the parking lock device 22A or 22B, rotate freely and cannot counteract the inclination to roll even through they stand on soil of good grip. It is possible with the instant reduction gear that a driver of the vehicle activates the other parking lock device 22B or 22A in addition to the already activated parking lock device 22A or 22B protecting the vehicle against undesirable rolling or slipping.

It obviously can also be further provided that a vehicle movement is detected via a sensor system located on the vehicle axles or also on any other suitable place of the vehicle in which case, depending on the vehicle movement detected, both parking lock pawls 23 and 25 of the parking lock devices 22A and 22B are simultaneously activated so as to reliably make possible to arrest the vehicle in the above described case when an activated parking lock device 22A or 22B alone does not prevent a movement of the vehicle.

Both parking lock pawls 23 and 25 can be controlled by a control device 26 via a kinematic, a hydraulic or any other appropriate actuation device.

In another advantageous embodiment of the inventive reduction gear, it obviously can be provided that the parking lock devices be designed as frictional system, such as a multi-disc brake or the like, and the output of the vehicle be stopped by frictional instead of form-locking engagement.

The parking lock devices 22A, 22B and the parking lock wheels thereof, which are integrated in the output shafts 7 and 8 of the reduction gear, in a development of the inventive reduction gear can be designed as separate parts connected with the first output shaft and the second output shaft in the area of the transmission output of the reduction gear.

FIG. 2 shows the multi-range transmission 1 with the reduction gear 3 and the main transmission 2 connected therewith, the difference between the multi-range transmission according to FIG. 1 and according to FIG. 2 being in essence in the area of the second output shaft 8. For this reason and for the sake of clarity, the same reference numerals are used in the description for parts having the same construction and function.

It results from the graph in FIG. 1 and FIG. 2 that the electric motor 10 is situated in a coupling area 27 between the reduction gear 3 and the main transmission 2 whereby the center of gravity of the reduction gear 3 is moved in direction of the coupling area 27. The displacement of the center of gravity of the reduction gear 3 results in that the electric motor 10 or the servo motor for the clutch 4 and the sliding sleeve 13 are loaded with a substantially lighter vibration load which, as is to be expected, leads to longer service life of the electric motor 10 and besides makes an additional connection of the electric motor 10 with the housing 28 of the main transmission 2 unnecessary.

The electric motor 10 is situated in the coupling area 27 between the reduction gear 3 and the main transmission 2 so as to project above an area of the main transmission 2 facing the reduction gear 3 and is positioned outside a housing 28 of the main transmission. Thereby the housing 28 of the main transmission 2 can be constructed independently of the electric motor 10 and the assembly of the multi-range transmission 1 is altogether simplified.

Alternative to this, it is obviously possible at the expert's discretion to simultaneously connect the electric motor via an appropriate fastening either with the housing of the distributor transmission 3 or the housing of the main transmission 2 or with both. In addition, it can also be provided that between the electric motor and the housing of the distributor transmission, the same as between the electric motor and the housing of the main transmission, there is respectively situated one damping element in order to ensure or obtain an uncoupling of vibration between the distributor transmission 3, the main transmission 2 and the electric motor 10, and also to prevent in the operation a hitting with each other of the units.

The second output shaft 8 has a first gear wheel 29 or an output wheel by which is led the chain 9 that connects the input shaft 6 and the second output shaft 8. In the area of the input shaft 6, the reduction gear 3 has a second gear wheel 30 which can be non-rotatably connected by the clutch 4 with the input shaft 6 and by which, likewise, the chain 9 is guided. This means that when the clutch 4 is closed, a torque introduced via the input shaft 6 in the reduction gear 3 is passed to the second output shaft 8 via the clutch 4, the second gear wheel 30, the chain 9 and the first gear wheel 29 connected non-rotatably with the second output shaft 8 or the output shaft 29.

In the design shown in FIG. 1, the second output shaft 8 is formed with one output flange 31 which, on its outer side, is designed with the outer toothing 24 of the parking lock device 22 and on which a universal shaft (known per se and not shown in detail), can be fastened with several screw connections. The universal shaft serves to connect the reduction gear 3 with one of the input shafts of the vehicle which, in turn, are directly connected with the drive wheels of the vehicle.

The universal shaft can comprise two constant velocity joints and one tubular part disposed between the two constant velocity joints, which constant velocity joints are provided to compensate an offset between the axis of rotation of the second output shaft 8 of the reduction gear 3 and the axis of rotation of the input shaft connected with the drive wheels of the vehicle.

With such a construction of the connection between the second output shaft 8 of the reduction gear 3 and one input shaft of the vehicle can be compensated variable offsets between the second output shaft 8 and the input shaft of the drive wheels that occur during the driving operation of the vehicle. Besides, the use of the universal shaft ensures a uniform transmission of a torque from the reduction gear 3 to the drive wheels operatively connected with the second input shaft 8.

The construction of the second output shaft 8 with the output flange 31 shown in FIG. 1 represents a design known from the practice in which a spacing between the reduction gear 3 and the main transmission 2 has to be provided very large so as to keep below an upper limit a deflection angle resulting from the offset between the second output shaft 8 and the input shaft of the drive wheels of a vehicle. The upper limit constitutes the value of the deflection angle of the universal shaft starting from which a transmission of the torque via the universal shaft is no longer possible.

To be able to reduce the spacing between the reduction gear 3 and the main transmission 2 in the coupling area 27 in FIG. 2, a constant velocity joint 33 located on the end of the universal shaft 32 facing the second output shaft 8 is integrated in the first gear wheel 29. Thus the spacing is enlarged between the two joints of the two constant velocity joints of the universal shaft 32 whereby a reduction of the deflection angle of the universal shaft 32 occurs. By means of this step, large offsets between the reduction gear 3 or the second output shaft 8 thereof and the input shaft of the drive wheels can be reconciled, as is the case in the design of the reduction gear 3 according to FIG. 1.

Due to the integration of the constant velocity joint 33 in the first gear wheel 29 of the reduction gear 3, it is possible to reduce a spacing between the reduction gear 3 and the main transmission 2 in the coupling area 27 without enlarging the deflection angle of the universal shaft in comparison to the solution of the reduction gear 3 shown in FIG. 1. The reduction of the spacing between the reduction gear 3 and the main transmission 2 advantageously results in a displacement of the center of gravity of the drive train in direction of the main transmission 2 whereby the stiffness and the bending inherent frequency of the drive train of the vehicle are altogether increased.

The integration of the constant velocity joint 33 in the first gear wheel 29 of the reduction gear 3 further results in a reduction of the total weight of the reduction gear 3 and of the universal shaft 32 when the multi-range transmission is more compactly designed. This is the case when the large spacing between constant velocity joints of a universal shaft is used for reducing the spacing between the reduction gear 3 and the main transmission 2, since the material use is less.

The universal shaft 32 in FIG. 2 is comprised of one hollow cylindrical section 34 and one cylindrical pivot 35 designed with a smaller diameter than the hollow cylindrical section 34 and which, in an area 36, is fused with a bearing shaft 37 of the constant velocity joint 33.

The bearing shaft 37 is non-rotatably connected with a bearing body 38 which is spherically designed on its outer side and, in turn, freely tiltably situated in a bearing shell 39. Between the bearing body 38 and the bearing shell 39, one known connection (not shown in detail) is porivded. Via the non-rotatable connection, the torque is transmitted by the chain 9 form the first gear wheel 29 to the constant velocity joint 33 and thus to the universal shaft 32.

### Reference numerals

1 multi-range transmission 20 second transmission bearing
2 main transmission 21 outer toothing of first output shaft
3 reduction transmission, 22 parking lock device distributor transmission 23 parking lock pawl of first output shaft
4 clutch 24 outer toothing of second output shaft
5 planetary gear set 25 pawling lock pawl of second output shaft
6 input shaft 26 control device
7 first output shaft 27 coupling range
8 second output shaft 28 housing of main transmission
9 chain 29 first gear wheel
10 electric motor 30 second gear wheel
11 shaft 31 output flange
12 swinger 32 universal shaft
13 sliding sleeve 33 constant velocity joint
14 ball threaded drive 34 hollow cylindrical section
15 ring gear 35 hollow cylindrica pivot
16 web 36 area
17 transmission device 37 bearing shaft
18 hydraulic pump 38 bearing body
19 first transmission bearing 39 bearing shell

1-6. (canceled)

7. A reduction gear (3) of a multi-range transmission (1) for a vehicle, especially for an all-wheel vehicle, which is situated between a main shaft (2) and an output of the vehicle and is designed with at least two ratio steps and with at least one parking lock device (22A, 22B) by means of which at least one part of the output can be stopped in an activated state, said at least one parking lock device (22A, 22B) being associated with at least one output shaft (7, 8) on an output side of the transmission in a manner such that in the activated state of the parking lock device (22) the output is stopped even when a power flow of a drive train is interrupted in an area of the reduction gear (3)

8. The reduction gear according to claim 7, wherein a parking lock wheel of said parking lock device (22A, 22B) is non-rotatably connected with the at least one output shaft (7, 8) of the output of the vehicle.

9. The reduction gear according to claim 7, wherein a parking lock wheel of said parking lock device (22A, 22B) is designed integrally with the at least one output shafts (7, 8).

10. The reduction gear according to claim 7, wherein one regulatable clutch (4) by which a torque can be optionally passed to one of an output shaft (7) or to several output shafts (7, 8) of the output is provided.

11. The reduction gear according to claim 7, wherein an additional parking lock device (22B) is provided with an additional parking lock wheel non-rotatably connected with an additional output shaft (8).

12. The reduction gear according to claim 11, wherein said parking lock wheels can be stopped independently of each other.
